(19) United States
(12) Patent Application Publication
(10) Pub. No.: US 2022/0212249 A1
(43) Pub. Date: Jul. 7, 2022

(54) FABRICATION OF LATTICE STRUCTURES WITH A THREE-DIMENSIONAL PRINTER

(71) Applicant: XEROX CORPORATION, NORWALK, CT (US)

(72) Inventors: Denis Cormier, Pittsford, NY (US); Dinesh Krishna Kumar Jayabal, Rochester, NY (US); Daniel Cormier, Pittsford, NY (US); Santokh S. Badesha, Pittsford, NY (US); Varun Sambhy, Pittsford, NY (US)

(73) Assignee: XEROX CORPORATION, NORWALK, CT (US)

(21) Appl. No.: 17/143,007

(22) Filed: Jan. 6, 2021

(51) Int. Cl. B22D 23/00; B33Y 30/00; B33Y 10/00

(52) U.S. Cl. CPC B22D 23/003; B33Y 10/00; B33Y 30/00

(57) ABSTRACT

A three-dimensional (3D) printer includes an ejector and a coil wrapped at least partially around the ejector. The 3D printer also includes a power source configured to transmit voltage pulses to the coil. The 3D printer includes a computing system causing one or more drops of the liquid to be jetted out of the nozzle, and a substrate configured to support the one or more drops and advance along a path defined by one or more arcuate contours, where the one or more arcuate contours define a first layer of a strut. One or more struts are printed from the first layer of the strut to a node of each strut. The one or more struts are printed from a first layer to a node and combine to fabricate a lattice structure including one or more vertical struts and/or one or more angled struts wherein each strut intersects with another strut at a node.

### TECHNICAL FIELD

The present teachings relate generally to three-dimensional (3D) printing and, more particularly, to systems and methods for building (e.g., printing) an object with a 3D printer having lattice structures with large strut diameters.

### BACKGROUND

A 3D printer builds (e.g., prints) a 3D object from a computer-aided design (CAD) model, usually by successively depositing material layer upon layer. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

In MHD printing, a liquid metal is jetted out through a nozzle of the 3D printer onto a substrate or onto a previously deposited layer of metal. When building engineered lattice structures via droplet jetting of this manner, it generally results in weak or fragile struts due to relatively cold weld joints between droplets that make up each cylindrical strut. Furthermore, the diameter of these lattice struts is effectively limited by the diameter of the droplets being jetted. Thus, a suitable method is needed to produce vertical or vertically angled support free struts having any desired diameter and greater strength.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A three-dimensional (3D) printer is disclosed. The three-dimensional printer also includes an ejector having a nozzle, a heating element configured to heat a solid in the ejector, thereby causing the solid to change to a liquid within the ejector, a coil wrapped at least partially around the ejector, a power source configured to supply one or more pulses of power to the coil, which cause one or more drops of the liquid to be jetted out of the nozzle, and a substrate configured to support the one or more drops as the one or more drops solidify to form a 3D object and advance along a path defined by one or more arcuate contours, where the one or more arcuate contours define a first layer of a strut.

In another embodiment, the 3D printer includes a substrate which is further configured to advance along a path defined by the one or more arcuate contours to print a plurality of layers of the strut onto the first layer of the strut. Each of the plurality of layers of the strut may be laterally offset from the first layer of the strut and may follow a spiral path. The strut may begin at a node where the strut meets a second strut. The 3D printer may print a strut where the strut may include at least one layer between the first layer of the strut and the node of the strut. The strut is printed from the first layer of the strut to the node of the strut. In various embodiments, the one or more struts may be hollow, solid, vertical, or angled and the one or more struts may combine to fabricate a lattice structure including one or more vertical struts and/or one or more angled struts, where the one or more vertical struts may include one or more nodes, the one or more angled struts may include one or more nodes and at least one of the one or more nodes of at least one of the one or more vertical struts intersects with at least one of the one or more nodes of at least one of the one or more angled struts.

A method for printing a three-dimensional (3D) object using a 3D printer is disclosed. The method includes jetting one or more drops of a liquid metal through a nozzle of the 3D printer, where the one or more drops land on a substrate, and where the one or more drops cool and solidify to form the 3D object, moving the substrate while the one or more drops are jetted to support the one or more drops as the one or more drops solidify to form a 3D object, and advancing the substrate along a path defined by one or more arcuate contours. The disclosed method also includes defining a first layer of a first strut. and printing a plurality of layers of the first strut onto the first layer of the first strut along the path defined by the one or more arcuate contours.

In another embodiment, the method includes printing a plurality of layers from the first layer of the first strut to a node of the first strut. The method may also include advancing the substrate along a path defined by a second of one or more arcuate contours to define a first layer of a second strut, printing a plurality of layers of the second strut onto the first layer of the second strut along a second path defined by the second one or more arcuate contours, and printing the plurality of layers from the first layer of the second strut to the node of the first strut to form a lattice structure.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a 3D printer (e.g., a MHD printer and/or multi-jet printer), according to an embodiment.

FIG. 2A illustrates a schematic top view of a first example of the 3D object on the substrate, according to an embodiment.

FIG. 2B illustrates a schematic side view of a first example of the 3D object on the substrate, according to an embodiment.

FIG. 3 illustrates a photograph of the first example of the 3D object of FIGS. 2A and 2B, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In 3D printing, and in particular, printing with liquid metal jetting, the fabrication of engineered lattice structures generally results in weak or fragile struts or other structural framework elements due to the relatively cold weld joints between droplets that make up each cylindrical strut. Furthermore, the diameter of the lattice struts is effectively limited by the diameter of the droplets being jetted. According to embodiments described herein, a method is provided to produce vertical and/or angled support-free struts having any desired diameter and greater strength. The proposed printer and printing method described in the embodiments may be capable of producing stronger struts or cylindrical beams and is based on printing spiral layers or a plurality of disks of a given diameter. Each printed spiral can have any desired outer diameter, thus allowing 3D printed struts of any desired diameter. In some embodiments, partially overlapping droplets follow a spiral toolpath which can continue until a disk or layer of any desired diameter has been printed.

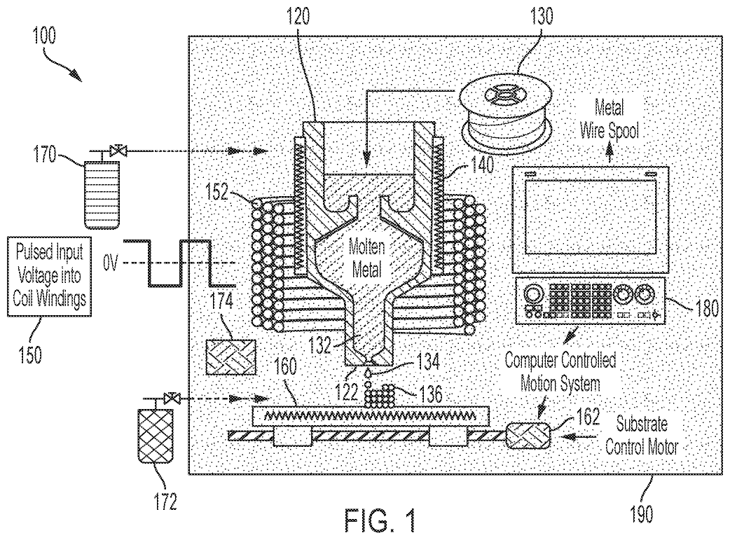

FIG. 1 depicts a schematic cross-sectional view of a 3D printer 100, according to an embodiment. The 3D printer 100 may include an ejector (also referred to as a body or pump chamber) 120. The ejector 120 may define an inner volume (also referred to as a cavity). A printing material 130 may be introduced into the inner volume of the ejector 120. The printing material 130 may be or include a metal, a polymer, or the like. For example, the printing material 130 may be or include aluminum or aluminum alloy (e.g., a spool of aluminum wire).

The 3D printer 100 may also include one or more heating elements 140. The heating elements 140 are configured to melt the printing material 130, thereby converting the printing material 130 from a solid state to a liquid state (e.g., liquid metal 132) within the inner volume of the ejector 120.

The 3D printer 100 may also include a power source 150 and one or more metallic coils 152 that are wrapped at least partially around the ejector 120. The power source 150 may be coupled to the coils 152 and configured to provide an electrical current to the coils 152. In one embodiment, the power source 150 may be configured to provide a step function direct current (DC) voltage profile (e.g., voltage pulses) to the coils 152, which may create an increasing magnetic field. The increasing magnetic field may cause an electromotive force within the ejector 120, that in turn causes an induced electrical current in the liquid metal 132. The magnetic field and the induced electrical current in the liquid metal 132 may create a radially inward force on the liquid metal 132, known as a Lorenz force. The Lorenz force creates a pressure at an inlet of a nozzle 122 of the ejector 120. The pressure causes the liquid metal 132 to be jetted through the nozzle 122 in the form of one or more liquid drops 134.

The 3D printer 100 may also include a substrate 160 that is positioned proximate to (e.g., below) the nozzle 122. The drops 134 may land on the substrate 160 and solidify to produce a 3D object 136. In one example, the 3D object 136 may be or include a strut, which may be part of a lattice structure. A strut is a structural piece or element of a lattice structure that provides support or structural definition to the lattice structure.

The 3D printer 100 may also include a substrate control motor 162 that is configured to move the substrate 160 while the drops 134 are being jetted through the nozzle 122, or during pauses between when the drops 134 are being jetted through the nozzle 122, to cause the 3D object 136 to have the desired shape and size. The substrate control motor 162 may be configured to move the substrate 160 in one dimension (e.g., along an X axis), in two dimensions (e.g., along the X axis and a Y axis), or in three dimensions (e.g., along the X axis, the Y axis, and a Z axis). In another embodiment, the ejector 120 and/or the nozzle 122 may be also or instead be configured to move in one, two, or three dimensions. In other words, the substrate 160 may be moved under a stationary nozzle 122, or the nozzle 122 may be moved above a stationary substrate 160. In yet another embodiment, there may be relative rotation between the nozzle 122 and the substrate 160 around one or two additional axes, such that there is four or five axis position control. In certain embodiments, both the nozzle 122 and the substrate 160 may move. For example, the substrate 160 may move in X and Y directions, while the nozzle 122 moves up and/or down in a Y direction.

The 3D printer 100 may also include one or more gas-controlling devices, which may be or include gas sources (two are shown: 170, 172). The first gas source 170 may be configured to introduce a first gas. The first gas may be or include an inert gas, such as helium, neon, argon, krypton, and/or xenon. In another embodiment, the first gas may be or include nitrogen. The first gas may include less than about 10% oxygen, less than about 5% oxygen, or less than about 1% oxygen.

In at least one embodiment, the first gas may be introduced at a location that is above where the second gas is introduced. For example, the first gas may be introduced at a location that is above the nozzle 122 and/or the coils 152. This may allow the first gas (e.g., argon) to form a shroud/sheath around the nozzle 122, the drops 134, the 3D object 136, and/or the substrate 160 to reduce/prevent the formation of oxide (e.g., aluminum oxide). Controlling the temperature of the first gas may also or instead help to control (e.g., minimize) the rate that the oxide formation.

The second gas source 172 may be configured to introduce a second gas. The second gas may be different than the first gas. The second gas may be or include oxygen, water vapor, carbon dioxide, nitrous oxide, ozone, methanol, ethanol, propanol, or a combination thereof. The second gas may include less than about 10% inert gas and/or nitrogen, less than about 5% inert gas and/or nitrogen, or less than about 1% inert gas and/or nitrogen. The second gas may be introduced at a location that is below the nozzle 122 and/or the coils 152. For example, the second gas may be introduced at a level that is between the nozzle 122 and the substrate 160. The second gas may be directed toward the nozzle 122, the falling drops 134, the 3D object 136, the substrate 160, or a combination thereof. This may help to control the properties (e.g., contact angle, flow, coalescence, and/or solidification) of the drops 134 and/or the 3D object 136.

The 3D printer 100 may also include another gas-controlling device, which may be or include a gas sensor 174. The gas sensor 174 may be configured to measure a concentration of the first gas, the second gas, or both. More particularly, the gas sensor 174 may be configured to measure the concentration proximate to the nozzle 122, the falling drops 134, the 3D object 136, the substrate 160, or a combination thereof. As used herein, “proximate to” refers to within about 10 cm, within about 5 cm, or within about 1 cm.

The 3D printer 100 may also include a computing system 180. The computing system 180 may be configured to control the printing of the 3D object 136. More particularly, the computing system 180 may be configured to control the introduction of the printing material 130 into the ejector 120, the heating elements 140, the power source 150, the substrate control motor 162, the first gas source 170, the second gas source 172, the gas sensor 174, or a combination thereof. As discussed in greater detail below, in one embodiment, the computing system 180 may control the rate at which the voltage pulses are provided from the power source 150 to the coils 152, and thus the corresponding rate at which the drops 134 are jetted through the nozzle 122. These two rates may be substantially the same.

In another embodiment, the computing system 180 may be configured to receive the measurements from the gas sensor 174, and also configured to control the first gas source 170 and/or the second gas source 172, based at least partially upon the measurements from the gas sensor 174, to obtain the desired gas concentration around the drops 134 and/or the object 136. In at least one embodiment, the concentration of the first gas (e.g., nitrogen) may be maintained between about 65% and about 99.999%, between about 65% and about 75%, between about 75% and about 85%, between about 85% and about 95%, or between about 95% and about 99.999%. In at least one embodiment, the concentration of the second gas (e.g., oxygen) may be maintained between about 0.000006% and about 35%, between about 0.000006% and about 0.00001%, between about 0.00001% and about 0.0001%, between about 0.0001% and about 0.001%, between about 0.001% and about 0.01%, between about 0.01% and about 0.1%, between about 0.1% and about 1%, between about 1% and about 10%, or between about 10% and about 35%.

The 3D printer 100 may also include an enclosure 190 that defines an inner volume (also referred to as an atmosphere). In one embodiment, the enclosure 110 may be hermetically sealed. In another embodiment, the enclosure 110 may not be hermetically sealed. In one embodiment, the ejector 120, the heating elements 140, the power source 150, the coils 152, the substrate 160, the computing system 170, the first gas source 180, the second gas source 182, the gas sensor 184, or a combination thereof may be positioned at least partially within the enclosure 190. In another embodiment, the ejector 120, the heating elements 140, the power source 150, the coils 152, the substrate 160, the computing system 170, the first gas source 180, the second gas source 182, the gas sensor 184, or a combination thereof may be positioned at least partially outside of the enclosure 190.

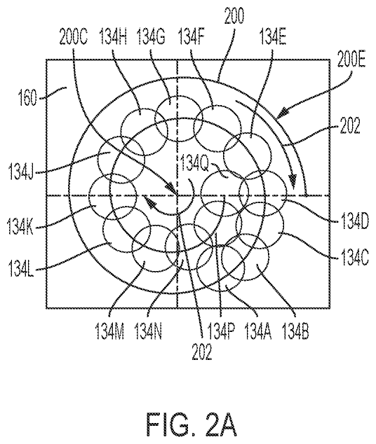

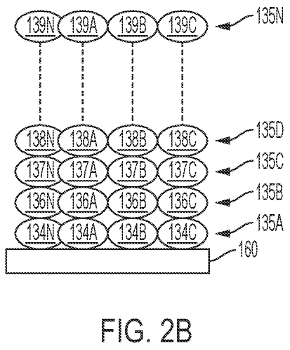

FIG. 2A illustrates a schematic top view of a first example of a first layer of the 3D object 136 on the substrate 160 that is formed when the 3D printer 100 operates according to an embodiment. To form the 3D object 136, the power source 150 may transmit a plurality of voltage pulses to the coils 152, which may cause a corresponding plurality of drops (fifteen drops are shown: 134A to 134Q, note that 134I and 134O are not used to avoid confusion with the numerals 1341 and 1340, respectively) to jet through the nozzle 122. The drops 134A to 134Q may be jetted at a predetermined frequency that allows each drop (e.g., drop 134A) to land on the substrate before the next drop (e.g., drop 130 4B) is jetted from the nozzle 122 and deposited on the previous drop 134A or the substrate 160. The predetermined frequency may be from about 10 Hz to about 500 Hz, which may cause from about 10 drops to about 50 drops to be jetted through the nozzle 122 per second. In the embodiment illustrated in FIG. 2A, the substrate 160 is configured to advance along the path defined by one or more arcuate contours, in this embodiment the arcuate path 200 or arcuate contour forms a spiral pattern that creates a disk or disk-shaped layer. The disk forms a foundational layer for a strut. An arcuate path or arcuate contour is defined as a curved outline or boundary shape that is followed by the advancing substrate during a jetting operation with the 3D printer 100. As the 3D printer 100 continues to operate, and subsequent drops 134B-134Q are jetted through the nozzle 122, the substrate continues to move along this arcuate path 200, in this case moving from the center 200C of the spiral path in a clockwise direction 202 outward towards a radial edge 200E from the center 200C of the spiral path 200. As the substrate 160 moves or advances along the arcuate path 200, a first layer 135A is deposited onto the substrate 160 in a spiral path. This first layer 135A is the first layer of a strut which is continuously formed as additional layers are deposited onto the first layer 135A. After the first layer is deposited onto the substrate 160, the substrate continues to advance along a similar path defined by the one or more acute contours to print or build the second layer upon the first layer in a spiral pattern. In the embodiment shown, the first drop 134A may be deposited onto the substrate 160, the second drop 134B may be deposited onto the first drop 134A, and so on as the substrate 160 advances. The drops 134B-134Q may not be in contact with the substrate 160. The drops 134A-134Q may be jetted such that each drop (e.g., drop 134B) is horizontally offset from the previously jetted drop (e.g., drop 134A) by less than a width of the previously jetted drop (e.g., drop 134A). This may result in the 3D object 136 being oriented at an initial angle with respect to the substrate 160 where the angle may be from about 20° to about 70° or from about 30° to about 60° (e.g., about 45°). In another embodiment, the arcuate path may be formed by the substrate moving or advancing in a continuous path of one or more arcuate contours, or alternatively the substrate may move in a noncontinuous path of one or more arcuate contours. In yet another embodiment, the drops may be deposited in such a manner that the substrate 160 advances in such a manner that the spiral path 200 begins at a radial edge 200E of the spiral path 200 and moves inward toward the center 200C of the spiral path 200. In another embodiment, the diameter of the spiral path 200 as measured from the center 200C to the radial edge 200E, is larger than the diameter of the one of the one or more drops after solidification. In certain embodiments, the tubular or cylindrical structure, or strut formed by this printing method to build a 3D lattice structure may be hollow, solid, or a combination of hollow and solid. Cylindrical struts formed in this manner may also be vertical or angled, and some structures may have a mixture of vertical and angled struts in certain embodiments. In another embodiment, an entire strut is printed up to a node location where two or more struts converge prior to the next strut being printed, distinguishing this approach from standard layer-by-layer 3D printing.

FIG. 2B illustrates a partial side view of subsequent layers, of the 3D object 136 formed on the substrate 160 in the manner described in regard to FIG. 2A, in this case a partial side view of a strut, according to an embodiment. The drops 134A-134Q may not be in contact with the substrate 160 in certain embodiments but may be built upon other structures or 3D objects previously printed by the 3D printer 100. As the 3D printer 100 continues to jet drops in the next disk or layer 135B, drops 136A-136Q, of which only drops 136A-136C and 136N are visible in this view, the drops 136A-136Q are jetted along a path defined by the same one or more arcuate contours as followed in the first foundational layer 135A of the strut. A path similar to path 200 is then followed repeatedly to print a plurality of layers 135C, 135D, and up to 135N of the strut on top of the first layer of the strut. In the embodiment shown, layer 135N is a node point, or a position along the length of a strut where it meets or joins or insects with a node or node point of another strut or structural element of the 3D object 136. Struts printed in the manner described in regard to FIG. 2B are printed with at least one layer between the foundational primary layer 135A and the node layer 135N of a strut. A strut according to an embodiment is printed continuously from the first layer 135A of the strut to the node layer 135N of the strut. As shown in FIG. 2A, the strut may be printed as a hollow strut, although alternate embodiments may print solid, vertical, angled struts, or combinations thereof. According to an embodiment, an outer diameter of the struts may be limited by or defined by the diameter of the drops jetted in the printing fabrication of the struts, after solidification. Drop diameter according to the embodiment shown may be from about 0.05 mm to about 1 mm, from about 0.1 mm to about 0.5 mm, or from about 0.25 mm to about 0.5 mm. Layer 135B and subsequent layers 135B-135N are deposited vertically upon foundation layer 135A, although the drops in layers 135B-135N may alternatively be jetted such that each layer (e.g., drops 136A-136Q forming layer 135B, and so on) is horizontally offset from the previously jetted layer (e.g., layer 135A) by less than a width of a previously jetted strut layer. This may result in the 3D object 136 being oriented at an initial angle with respect to the substrate 160, for example, the angle may be from about 20° to about 70° or from about 30° to about 60° (e.g., about 45°). As shown the angle of layers 135A-135N relative to one another is approximately 0° with respect to the substrate 160.

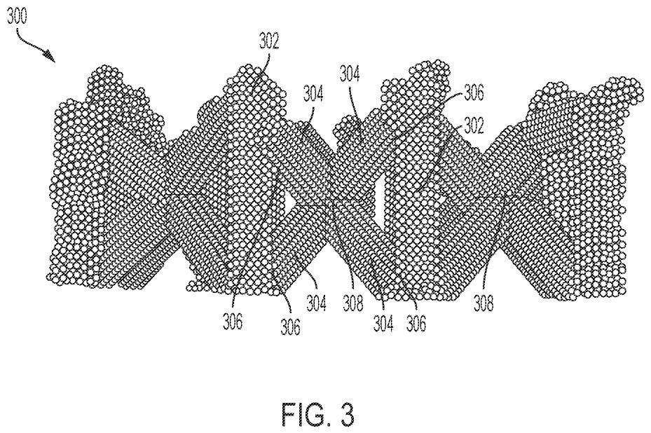

FIG. 3 illustrates a photograph of the first example of the 3D object fabricated as described in FIGS. 2A and 2B, according to an embodiment. The lattice structure 300, is a structure fabricated from one or more vertical struts 302, and one or more angled struts 304. Each of the vertical struts 302 in the lattice structure 300 defines a node 306 or node point (a connection point between one or more struts in a lattice structure) along the length of the vertical strut 302. Each of the angled struts 304 defines a node 308 or node point along the length of the vertical strut 304. According to an embodiment, the lattice structure 300 shown in FIG. 3 has multiple vertical struts 302 spaced apart and connected or coupled with several angled struts 304, in this embodiment shown as an “X-shaped” support, where each angled strut 304 is coupled to a vertical strut 302 at a node point 306 on the vertical strut 302. The “X-shaped” support structure is fabricated from four angled struts 304 meeting at a center node 308.

The lattice structure 300 in FIG. 3 can be printed or fabricated, according to an embodiment, such that a vertical strut 302 within the lattice structure 300 is printed layer by layer from bottom to a top of the structure 300. Angled or diagonal struts 304 may be printed such that the first layer of one or more angled struts 304 is printed, then a subsequent second layer of the one or more angled struts 304 is printed. The layer-by-layer printing of an angled strut 304 may continue until a node point 308 is reached that would join a vertical strut 302 at its node point 306. At this time, the 3D printer 100 and the substrate 160 would follow an arcuate path in such a manner that a vertical strut 302 could be completed by repetitive layers vertically on top of one another, or alternatively by forming a spiral disk layer of all angled and/or vertical struts in a lattice structure to another node point before continuing to print the subsequent layers. In this manner, a 3D printer 100 as disclosed herein may fabricate a lattice structure having one or more vertical struts and one or more angled struts, wherein the one or more vertical struts may include one or more nodes, the one or more angled struts comprise one or more nodes. In the fabricated lattice structure, at least one of the one or more nodes of at least one of the one or more vertical struts intersects with at least one of the one or more nodes of at least one of the one or more angled struts. In an embodiment, the lattice structures are fabricated by 3D printing of aluminum or aluminum alloy. In another embodiment, plastic or polymer-based printing materials may be used with the use of alternate methods of 3D jetting and fabrication methods.

In certain embodiments, a 3D object 136 such as a lattice structure may be printed using a 3D printer 100 by jetting one or more drops of a liquid metal through a nozzle of the 3D printer, wherein the one or more drops land on a substrate, and wherein the one or more drops cool and solidify to form the 3D object. The substrate may be moved while the one or more drops are jetted to support the one or more drops as the one or more drops solidify to form a 3D object and the substrate is advanced along a path defined by one or more arcuate contours, thereby defining a first layer of a strut. The path defined by one or more arcuate contours may be a spiral path. Next, a plurality of layers of the strut is continuously printed onto the first layer of the strut along the path defined by the one or more arcuate contours until a node point of the strut is reached. In an embodiment, one or more of the subsequent layers are horizontally offset from the location of the first layer of the strut while alternate embodiments may have one or more of the subsequent layers positioned directly onto the first layer. This method of jetting may enable the construction or fabrication of intricate structures having engineered lattice structures. The lattice structures according to an embodiment may further have a solid printed outer skin that encapsulates the internal supporting lattice structure, a formation that is difficult or impossible to make with existing printing methods.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A three-dimensional (3D) printer, comprising:
an ejector comprising a nozzle;
a heating element configured to heat a solid in the ejector, thereby causing the solid to change to a liquid within the ejector;
a coil wrapped at least partially around the ejector;
a power source configured to supply one or more pulses of power to the coil, which cause one or more drops of the liquid to be jetted out of the nozzle; and
a substrate configured to:
support the one or more drops as the one or more drops solidify to form a 3D object;
and
advance along a path defined by one or more arcuate contours, wherein the one or more arcuate contours define a first layer of a strut.

2. The 3D printer of claim 1, wherein the substrate is further configured to advance along a path defined by the one or more arcuate contours to print a plurality of layers of the strut onto the first layer of the strut.

3. The 3D printer of claim 2, wherein each of the plurality of layers of the strut is laterally offset from the first layer of the strut.

4. The 3D printer of claim 2, the strut further comprising a node, wherein the strut begins at a node where the strut meets a second strut.

5. The 3D printer of claim 4, the strut further comprising at least one layer between the first layer of the strut and the node of the strut.

6. The 3D printer of claim 4, wherein the strut is printed from the first layer of the strut to the node of the strut.

7. The 3D printer of claim 2, wherein the one or more struts are hollow.

8. The 3D printer of claim 2, wherein the one or more struts are solid.

9. The 3D printer of claim 2, wherein the one or more struts are vertical.

10. The 3D printer of claim 2, wherein the one or more struts are angled.

11. The 3D printer of claim 2, wherein a diameter of the one or more struts is larger than a diameter of the one or more drops after solidification.

12. The 3D printer of claim 2, wherein the one or more arcuate contours comprise a spiral path.

13. The 3D printer of claim 12, wherein the spiral path begins at a radial edge of the spiral path and moves inward towards a center of the spiral path.

14. The 3D printer of claim 12, wherein the spiral path begins at a center of the spiral path and moves outward towards a radial edge of the spiral path.

15. The 3D printer of claim 2, the substrate further configured to fabricate a lattice structure comprised of one or more vertical struts and one or more angled struts, wherein:
the one or more vertical struts comprise one or more nodes;
the one or more angled struts comprise one or more nodes; and
at least one of the one or more nodes of at least one of the one or more vertical struts intersects with at least one of the one or more nodes of at least one of the one or more angled struts.

16. A three-dimensional (3D) printer, comprising:
an ejector comprising a nozzle;
a heating element configured to heat a solid in the ejector, thereby causing the solid to change to a liquid within the ejector;
a coil wrapped at least partially around the ejector;
a power source configured to supply one or more pulses of power to the coil, which cause one or more drops of the liquid to be jetted out of the nozzle; and
the nozzle configured to advance along a path defined by one or more arcuate contours, wherein the one or more arcuate contours comprises a spiral path beginning at a center of the spiral path and advancing outward toward a radial edge of the spiral path to define a first layer of a strut.

17. The 3D printer of claim 16, further comprising a substrate configured to fabricate a lattice structure comprised of one or more vertical struts and one or more angled struts, wherein:
the one or more vertical struts comprise one or more nodes;
the one or more angled struts comprise one or more nodes; and
at least one of the one or more nodes of at least one of the one or more vertical struts intersects with at least one of the one or more nodes of at least one of the one or more angled struts.

18. A method for printing a three-dimensional (3D) object using a 3D printer, the method comprising:
jetting one or more drops of a liquid metal through a nozzle of the 3D printer, wherein the one or more drops land on a substrate, and wherein the one or more drops cool and solidify to form the 3D object;
moving the substrate while the one or more drops are jetted to support the one or more drops as the one or more drops solidify to form a 3D object; and
advancing the substrate along a path defined by one or more arcuate contours;
defining a first layer of a first strut; and
printing a plurality of layers of the first strut onto the first layer of the first strut along the path defined by the one or more arcuate contours.

19. The method of claim 18, wherein the path defined by the one or more arcuate contours comprises a first spiral path.

20. The method of claim 18, further comprising printing the plurality of layers from the first layer of the first strut to a node of the first strut.

21. The method of claim 20, further comprising:
advancing the substrate along a path defined by a second of one or more arcuate contours;
defining a first layer of a second strut;
printing a plurality of layers of the second strut onto the first layer of the second strut along a second path defined by the second one or more arcuate contours; and
printing the plurality of layers from the first layer of the second strut to the node of the first strut to form a lattice structure.
